(19) United States
(12) Patent Application Publication
(10) Pub. No.: US 2026/0042420 A1
(43) Pub. Date: Feb. 12, 2026

(54) METHOD AND APPARATUS FOR PASSIVE ENTRY SYSTEM UTILIZING VEHICLE SENSOR

(71) Applicant: 42dot Inc., Seoul (KR)

(72) Inventors: Byung Gyu KIM, Seongnam (KR); Jae Bong Lim, Seongnam (KR)

(21) Appl. No.: 19/290,653

(22) Filed: Aug. 5, 2025

(30) Foreign Application Priority Data
Aug. 7, 2024 (KR) 10-2024-0105338

(51) Int. Cl. B60R 25/31

(52) U.S. Cl. CPC B60R 25/31

(57) ABSTRACT

Provided is a method of performing a passive entry operation by using a vehicle sensor, the method including: determining first location information about a mobile device by using a radio-frequency (RF)-based sensor mounted on a vehicle; determining second location information about at least one object around the vehicle by using at least one sensor mounted on the vehicle; determining final location information about the mobile device by fusing the first location information with the second location information; and controlling an operation of the vehicle based on the final location information about the mobile device.

### CROSS-REFERENCE TO RELATED APPLICATION

This application is based on and claims priority under 35 U.S.C. § 119 to Korean Patent Application No. 10-2024-0105338, filed on Aug. 7, 2024, in the Korean Intellectual Property Office, the disclosure of which is incorporated by reference herein in its entirety.

### BACKGROUND

### 1. Field

The present disclosure relates to a passive entry system utilizing a vehicle sensor, and more particularly, to a method for a passive entry system that fuses a radio-frequency (RF)-based sensor with a vehicle sensor, and an apparatus for implementing the method.

### 2. Description of the Related Art

A passive entry system is a function that enables a driver to lock or unlock a vehicle's door without using a car key, enhancing convenience and security by allowing a smart phone to serve as the car key.

To implement a highly marketable passive entry system, accurate distance measurement is essential.

The related art implements a passive entry system by measuring the distance between a smart phone and a vehicle by using radio-frequency (RF)-based sensors, such as ultra-wideband (UWB) sensors. However, ensuring the accuracy of RF signal-based positioning, which is used in the related art to implement passive entry systems, is a significant challenge. To solve this problem, a method of implementing a passive entry system by fusing RF-based sensors with smart phone sensors has been proposed, but this method has an issue in that functional consistency is not guaranteed, because the types of supported sensors and their specific characteristics differ depending on the smart phone model.

The above-mentioned background art is technical information possessed by the inventor for the derivation of the present disclosure or acquired during the derivation of the present disclosure, and cannot necessarily be said to be a known technique disclosed to the general public prior to the filing of the present disclosure.

### SUMMARY

Provided are methods and apparatuses for a passive entry system utilizing a vehicle sensor.

According to an aspect of an embodiment, a method includes: determining first location information about a mobile device by using a radio-frequency (RF)-based sensor mounted on a vehicle; determining second location information about at least one object around the vehicle by using at least one sensor mounted on the vehicle; determining final location information about the mobile device by fusing the first location information with the second location information; and controlling an operation of the vehicle based on the final location information about the mobile device.

In the method, the determining of the final location information about the mobile device by fusing the first location information with the second location information may include determining whether the first location information and the second location information match, by using the first location information about the mobile device and the second location information about the at least one object around the vehicle.

In the method, the determining of whether the first location information and the second location information match may include determining whether the first location information and the second location information match, based on a change in the first location information over time and a change in the second location information over time.

In the method, the determining of whether the first location information and the second location information match may include: distinguishing zones based on a distance from the vehicle; and varying, according to the zones, a criterion for determining whether the first location information and the second location information match.

The method may further include, in the determining of the final location information about the mobile device by fusing the first location information with the second location information, correcting an error in the first location information based on the second location information.

In the method, in the determining of the second location information about the at least one object around the vehicle by using the at least one sensor mounted on the vehicle, sensors of multiple types mounted on the vehicle may be used.

The method may further include converting, to a common format, information obtained through the sensors of the multiple types mounted on the vehicle.

According to an aspect of another embodiment, an apparatus includes: a memory storing at least one program; and a processor configured to execute the at least one program to perform an operation, wherein the processor is further configured to determine first location information about a mobile device by using an RF-based sensor mounted on a vehicle, determine second location information about at least one object around the vehicle by using at least one sensor mounted on the vehicle, determine final location information about the mobile device by fusing the first location information with the second location information, and control an operation of the vehicle based on the final location information about the mobile device.

According to an aspect of another embodiment, there may be provided a computer-readable recording medium having stored therein a program for executing the method.

### BRIEF DESCRIPTION OF THE DRAWINGS

These and/or other aspects will become apparent and more readily appreciated from the following description of the embodiments, taken in conjunction with the accompanying drawings in which:

FIGS. 1 to 3 are diagrams for describing an autonomous driving method according to an embodiment;

FIG. 4 is a diagram schematically illustrating radio-frequency (RF)-based sensors performing RF signal-based positioning on a mobile device, according to an embodiment;

FIG. 5 is a diagram schematically illustrating a plurality of sensors mounted on a vehicle and a plurality of objects around the vehicle, according to an embodiment;

FIG. 6A is a diagram schematically illustrating a mobile device, at least one object around a vehicle, and zones partitioned around the vehicle, according to an embodiment;

FIG. 6B is a diagram illustrating grouped location information about objects around a vehicle and second location information, according to an embodiment;

FIG. 7 is a diagram schematically illustrating a mobile device, objects around a vehicle, and zones partitioned around the vehicle, together with changes in the locations of the mobile device, the objects around the vehicle over time, according to an embodiment;

FIG. 8 is a flowchart of a method of performing a passive entry operation by using a vehicle sensor, according to an embodiment; and

FIG. 9 is a block diagram of a passive entry system providing apparatus according to an embodiment.

### DETAILED DESCRIPTION

As the present disclosure allows for various changes and numerous embodiments, reference will now be made to specific example embodiments, some of which are illustrated in the drawings and described in detail. The effects and features of the present disclosure and methods of achieving them will become clear with reference to the embodiments described in detail below with the drawings. However, the present disclosure is not limited to the embodiments disclosed below, and may be implemented in various forms.

Hereinafter, embodiments of the present disclosure will be described in detail with reference to the accompanying drawings, and the same or corresponding components will be denoted by the same reference numerals when described with reference to the accompanying drawings, and thus, their descriptions that are already provided will be omitted.

In the following embodiments, terms such as “first,” “second,” etc., are used only to distinguish one component from another, and such components must not be limited by these terms.

In the following embodiments, the singular form is intended to include the plural form, unless the context clearly indicates otherwise.

In the following embodiments, the terms “comprise,” “include,” “have,” and the like specify the presence of stated features or components, but do not preclude the presence or addition of one or more other features or components.

When a certain embodiment may be differently implemented, particular operations may be performed differently from the sequence described herein. For example, two processes, which are successively described herein, may be substantially simultaneously performed, or may be performed in a process sequence opposite to a described process sequence.

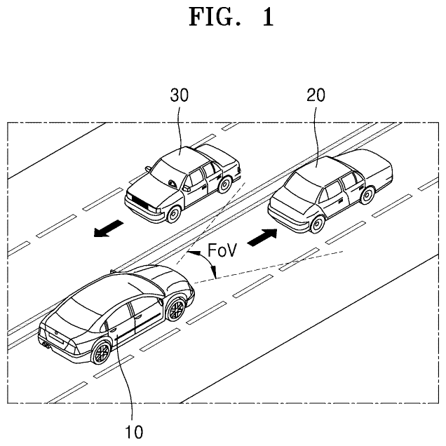

FIGS. 1 to 3 are diagrams for describing an autonomous driving method according to an embodiment.

Referring to FIG. 1, an autonomous driving apparatus according to an embodiment of the present disclosure may be mounted in a vehicle to implement an autonomous vehicle 10. The autonomous driving apparatus mounted in the autonomous vehicle 10 may include various sensors for collecting information about the surrounding environment. For example, the autonomous driving apparatus may detect a movement of a preceding vehicle 20 traveling in front of the autonomous vehicle 10, through an image sensor and/or an event sensor mounted on the front side of the autonomous vehicle 10. The autonomous driving apparatus may further include sensors for detecting, in addition to the preceding vehicle 20 traveling in front of the autonomous vehicle 10, another traveling vehicle 30 traveling in an adjacent lane, and pedestrians around the autonomous vehicle 10.

At least one of the sensors for collecting information about the environment around the autonomous vehicle may have a certain field of view (FoV), as illustrated in FIG. 1. For example, in a case in which a sensor mounted on the front side of the autonomous vehicle 10 has the FoV as illustrated in FIG. 1, information detected at the center of the sensor may have a relatively high importance. This may be because the information detected at the center of the sensor predominantly includes information corresponding to the movement of the preceding vehicle 20.

The autonomous driving apparatus may process information collected by the sensors of the autonomous vehicle 10 in real time to control the movement of the autonomous vehicle 10, while storing, in a memory device, at least part of the information collected by the sensors.

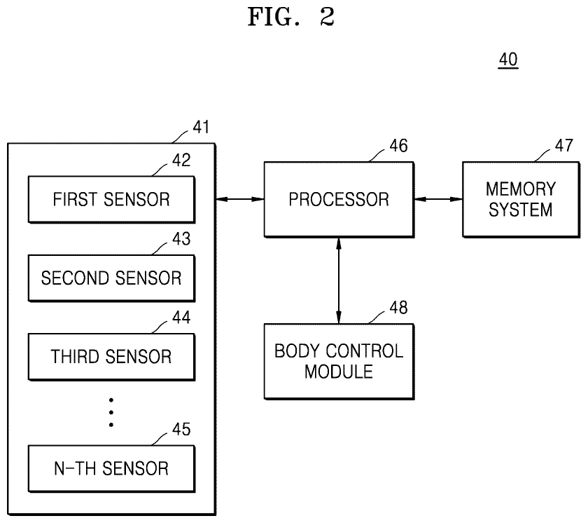

Referring to FIG. 2, an autonomous driving apparatus 40 may include a sensor unit 41, a processor 46, a memory system 47, a body control module 48, and the like. The sensor unit 41 may include a plurality of sensors 42 to 45, and the plurality of sensors 42 to 45 may include an image sensor, an event sensor, an illuminance sensor, a global positioning system (GPS) device, an acceleration sensor, and the like.

Data collected by the sensors 42 to 45 may be delivered to the processor 46. The processor 46 may store, in the memory system 47, the data collected by the sensors 42 to 45, and control the body control module 48 based on the data collected by the sensors 42 to 45 to determine a movement of the vehicle. The memory system 47 may include two or more memory devices and a system controller for controlling the memory devices. Each of the memory devices may be provided as a single semiconductor chip. In addition to the system controller of the memory system 47, each of the memory devices included in the memory system 47 may include a memory controller, which may include an artificial intelligence (AI) computation circuit such as a neural network. The memory controller may generate computational data by applying certain weights to data received from the sensors 42 to 45 or the processor 46, and store the computational data in a memory chip.

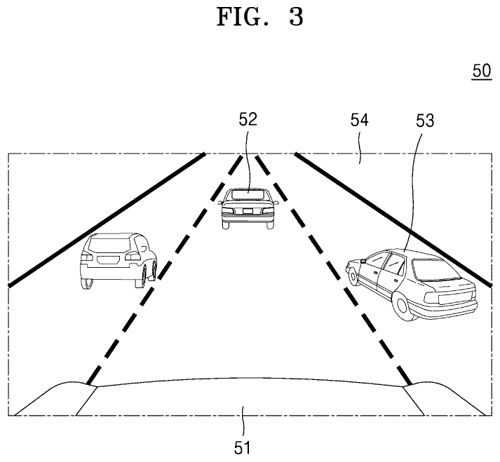

FIG. 3 is a diagram illustrating an example of image data obtained by a sensor of an autonomous vehicle equipped with an autonomous driving apparatus. Referring to FIG. 3, image data 50 may be data obtained by a sensor mounted on the front side of the autonomous vehicle. Thus, the image data 50 may include a front part 51 of the autonomous vehicle, a preceding vehicle 52 in the same lane as the autonomous vehicle, a traveling vehicle 53 around the autonomous vehicle, a region of non-interest 54, and the like.

In the image data 50 according to the embodiment illustrated in FIG. 3, data regarding a region including the front part 51 of the autonomous vehicle and the region of non-interest 54 may be unlikely to affect the driving of the autonomous vehicle. In other words, the front part 51 of the autonomous vehicle and the region of non-interest 54 may be considered data with a relatively low importance.

On the other hand, the distance to the preceding vehicle 52 and a lane-changing movement of the traveling vehicle 53 may be significantly important factors in terms of safe driving of the autonomous vehicle. Accordingly, in the image data 50, data regarding a region including the preceding vehicle 52 and the traveling vehicle 53 may have a relatively high importance in terms of the driving of the self-driving car.

A memory device of the autonomous driving apparatus may store the image data 50 received from the sensor, with different weights assigned to the respective regions. For example, a high weight may be assigned to data regarding a region including the preceding vehicle 52 and the traveling vehicle 53, while a low weight may be assigned to data regarding a region including the front part 51 of the autonomous vehicle and the region of non-interest 54.

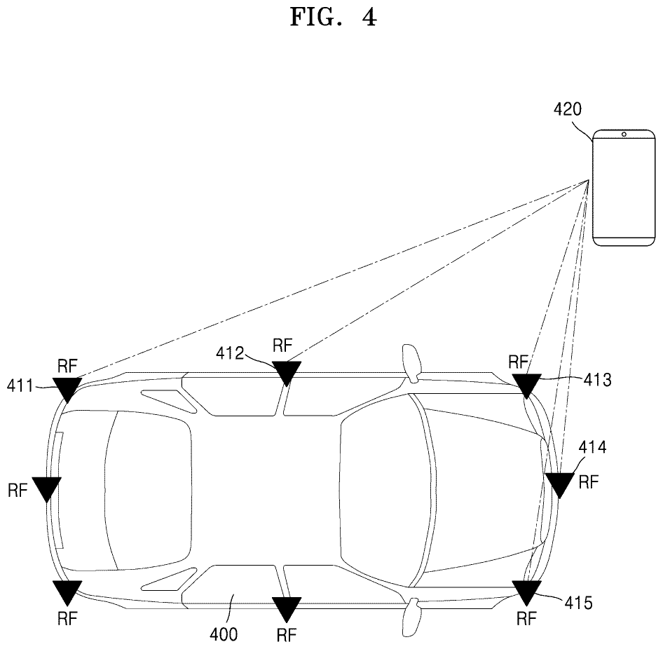

FIG. 4 is a diagram schematically illustrating radio-frequency (RF)-based sensors performing RF signal-based positioning on a mobile device, according to an embodiment. Referring to FIG. 4, RF-based sensors 411, 412, 413, 414, and 415 mounted on a vehicle 400 may perform RF signal-based positioning on a mobile device 420.

To implement a passive entry system, a passive entry system providing apparatus may determine location information about the mobile device 420.

In some embodiments, the passive entry system providing apparatus may determine location information about the mobile device 420 to implement a passive entry system, which enables a driver to lock or unlock a door of the vehicle 400 without using a car key. In other words, the passive entry system providing apparatus may implement a passive entry system by using the mobile device 420 as a terminal that replaces a car key. The operations of the vehicle 400 that may be controlled by the passive entry system are not limited to locking or unlocking the door of the vehicle 400.

In some embodiments, the passive entry system providing apparatus may determine first location information about the mobile device 420 by using RF signal-based positioning. Hereinafter, location information about the mobile device 420 that is determined by the passive entry system providing apparatus using the RF-based sensors 411, 412, 413, 414, and 415 mounted on the vehicle 400 will be referred to as first location information.

According to an embodiment of the present disclosure, the passive entry system providing apparatus may perform RF signal-based positioning on the mobile device 420 by using the RF-based sensors 411, 412, 413, 414, and 415 mounted on the vehicle 400.

In some embodiments, to perform the RF signal-based positioning for identifying the location of the mobile device 420 by using RF signals, RF signals such as Bluetooth (BT), ultra-wideband (UWB), Wireless Fidelity (Wi-Fi), or low-frequency (LF) signals may be used.

In this case, the passive entry system providing apparatus may determine the location of a user carrying the mobile device 420, by using distance data between a plurality of RF-based sensors mounted on the vehicle 400 and the mobile device 420. In some embodiments, the passive entry system providing apparatus may simultaneously use the RF-based sensors 411, 412, 413, 414, and 415 of various types to perform RF signal-based positioning. That is, it is not necessary to use only one type of RF-based sensor to perform RF signal-based positioning.

In some embodiments, the passive entry system may communicate with the mobile device 420 by using the plurality of RF-based sensors 411, 412, 413, 414, and 415 mounted on the vehicle 400, to determine first location information, which indicates the location of the mobile device 420.

Here, the passive entry system may perform RF signal-based positioning by using positioning methods such as time difference of arrival (TDoA), time of flight (ToF)/two-way ranging (TWR), angle of arrival (AoA)/angle of departure (AoD), or RF fingerprinting.

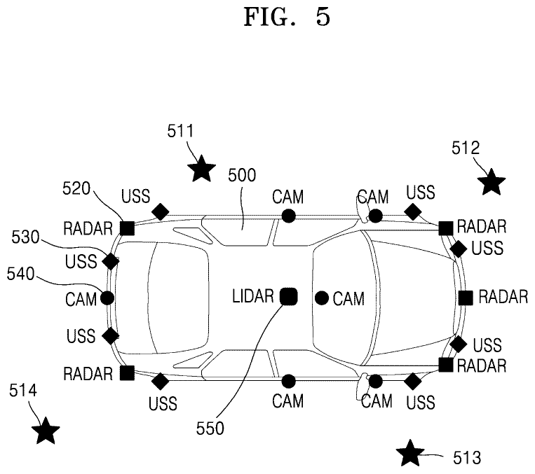

FIG. 5 is a diagram schematically illustrating a plurality of sensors mounted on a vehicle and a plurality of objects around the vehicle, according to an embodiment.

According to an embodiment of the present disclosure, the passive entry system providing apparatus may determine location information about at least one object around a vehicle 500 by using one or more sensors 520, 530, 540, and 550 mounted on the vehicle 500. Hereinafter, location information about one or more objects 511, 512, 513, and 514 around the vehicle 500, which is determined by the passive entry system providing apparatus using the one or more sensors 520, 530, 540, and 550 mounted on the vehicle 500, will be referred to as second location information.

The types of the sensors 520, 530, 540, and 550 mounted on the vehicle 500 that are used by the passive entry system providing apparatus to determine second location information may vary. In some embodiments, an ultrasonic sensor (USS) 530, a radio detection and ranging (RADAR) 520, a camera (CAM) 540, and a light detection and ranging (LIDAR) 550 may be mounted on the vehicle 500 for use. However, the types of the sensors 520, 530, 540, and 550 mounted on the vehicle 500 are not limited to the types of sensors described above.

In some embodiments, the sensors 520, 530, 540, and 550 mounted on the vehicle 500 may recognize one or more objects 511, 512, 513, and 514 around the vehicle 500. Here, the passive entry system providing apparatus may determine second location information about at least one object around the vehicle by using information about the one or more objects 511, 512, 513, and 514 that is obtained by the sensors 520, 530, 540, and 550 mounted on the vehicle 500.

In some embodiments, to recognize the one or more objects 511, 512, 513, and 514 around the vehicle, the passive entry system providing apparatus may perform three-dimensional (3D) object detection, bird's-eye-view object detection, point cloud object detection, or the like, by using the sensors 520, 530, 540, and 550 mounted on the vehicle 500.

According to an embodiment, the passive entry system providing apparatus may determine the second location information by combining information obtained by the plurality of sensors 520, 530, 540, and 550 mounted on the vehicle 500. Here, it is not necessary to use only information obtained by one type of sensor mounted on the vehicle 500, and the passive entry system providing apparatus may determine the second location information by using a fusion of information obtained by the sensors 520, 530, 540, and 550 of various types mounted on the vehicle 500.

In an embodiment, to fuse information obtained by the sensors 520, 530, 540, and 550 of various types mounted on the vehicle 500, the passive entry system providing apparatus may synchronize information obtained through the sensors 520, 530, 540, and 550 of multiple types mounted on the vehicle 500.

In some embodiments, in this sensor fusion process, the passive entry system providing apparatus may perform preprocessing on information obtained by each of the sensors 520, 530, 540, and 550 to synchronize the information obtained through the sensors 520, 530, 540, and 550 of multiple types mounted on the vehicle 500.

Here, during the preprocessing of the information obtained through each of the sensors 520, 530, 540, and 550, the information obtained by the sensors 520, 530, 540, and 550 of multiple types mounted on the vehicle 500 may be aligned based on the same time reference. In some embodiments, the information obtained through the sensors 520, 530, 540, and 550 of multiple types mounted on the vehicle 500 may be converted from its native coordinate system into a common coordinate system for alignment.

As described above, the passive entry system providing apparatus may determine the second location information by using information about the objects 511, 512, 513, and 514 around the vehicle 500, which is obtained by the sensors 520, 530, 540, and 550 of various types mounted on the vehicle 500.

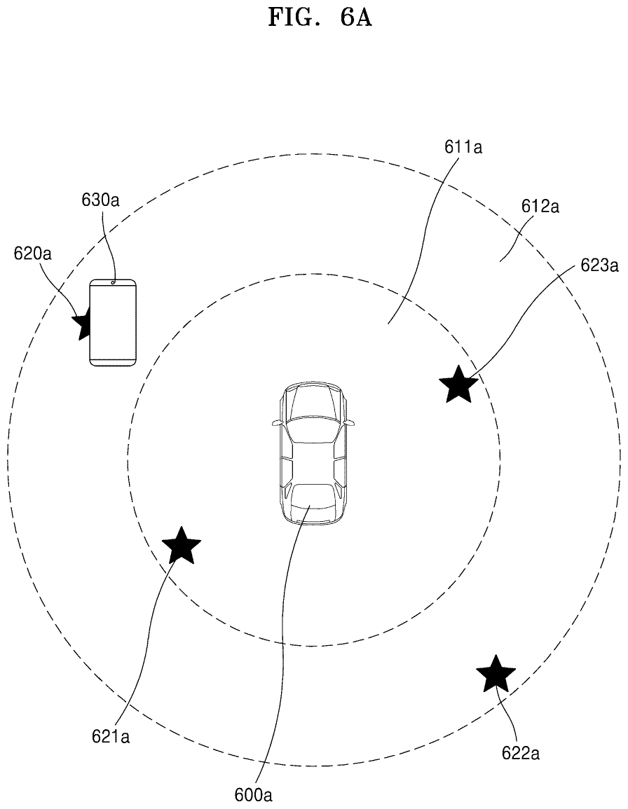

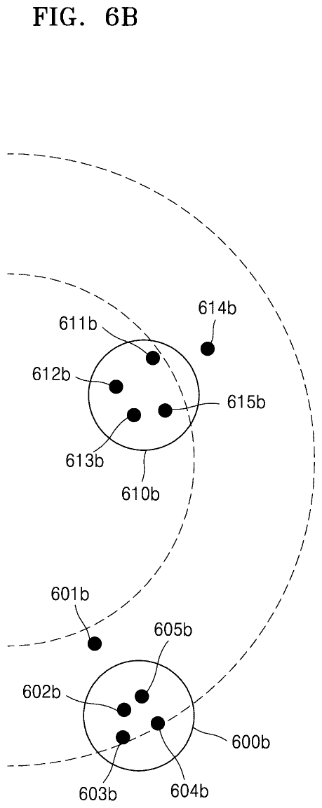

FIG. 6A is a diagram schematically illustrating a mobile device, at least one object around a vehicle, and zones partitioned around the vehicle, according to an embodiment.

According to an embodiment of the present disclosure, the passive entry system providing apparatus may determine final location information about a mobile device 630a by fusing first location information about the mobile device 630a with second location information about one or more objects 620a, 621a, 622a, and 623a around the vehicle. In some embodiments, the determined final location information may be used to provide a passive entry system.

In more detail, the passive entry system providing apparatus according to an embodiment of the present disclosure may determine the final location information about the mobile device 630a by determining whether the first location information about the mobile device 630a matches the second location information about the one or more objects 620a, 621a, 622a, and 623a around the vehicle.

Here, the matching of the first location information and the second location information by the passive entry system providing apparatus may mean cross-checking the location of the mobile device 630a against the location of the one or more objects 620a, 621a, 622a, and 623a around the vehicle.

In some embodiments, when the first location information about the mobile device 630a and the second location information about the one or more objects 620a, 621a, 622a, and 623a around the vehicle overlap each other, the passive entry system providing apparatus may determine that the first location information and the second location information match.

In some embodiments, the passive entry system providing apparatus may determine the final location information about the mobile device 630a, based on the first location information about the mobile device 630a, and the second location information about the one or more objects 620a, 621a, 622a, and 623a around the vehicle.

Here, the passive entry system providing apparatus may calculate a single average location value by averaging a plurality of pieces of location data, and determine the average location value as the final location information about the mobile device 630a. According to an embodiment, the passive entry system providing apparatus may obtain a location average (an average location value) between the first location information and the second location information about at least one object 620a around the vehicle, which matches the mobile device 630a, and determine final location information about the mobile device 630a by using the obtained location average.

According to another embodiment, the passive entry system providing apparatus may obtain a location average for a plurality of pieces of second location information determined to match the mobile device 630a, and determine final location information about the mobile device 630a based on the obtained location average.

According to an embodiment of the present disclosure, when determining the final location information about the mobile device 630a, the passive entry system providing apparatus may correct an error in the first location information based on the second location information.

In some embodiments, the passive entry system providing apparatus may perform a location correction on the first location information based on the second location information. Here, the location correction may refer to a process of correcting a difference between an actual location and a measured location to increase the accuracy of the collected data.

According to an embodiment of the present disclosure, to increase the accuracy of first location information measured via RF-based sensors, the passive entry system providing apparatus may perform a location correction on the first location information based on second location information measured via a sensor mounted on the vehicle. This may reflect the fact that location information measured by using a sensor mounted on a vehicle is typically more similar to the actual location information than location information measured by using an RF-based sensor.

Here, the passive entry system providing apparatus may correct the error in the first location information by replacing the first location information with the second location information. According to another embodiment of the present disclosure, the passive entry system providing apparatus may correct an error in the first location information based on the second location information by applying a predetermined correction function. The method of correcting an error in first location information based on second location information may vary and is not limited to the examples described above.

FIG. 6B is a diagram illustrating grouped location information about objects around a vehicle and second location information, according to an embodiment.

In some embodiments, to determine whether first location information and second location information match, the passive entry system providing apparatus may perform clustering. Here, clustering may refer to a technique of grouping data into groups based on similarity.

For example, the passive entry system providing apparatus may perform clustering based on pieces of second location information 601b, 602b, 603b, 604b, 605b, 611b, 612b, 613b, 614b, and 615b about one or more objects around the vehicle to group the locations of one or more objects around the vehicle recognized by a sensor mounted on the vehicle.

Here, the passive entry system providing apparatus may determine whether a match occurs, by fusing grouped pieces of location information 600b and 610b about objects around the vehicle, with first location information about a mobile device.

In some embodiments, the passive entry system providing apparatus may obtain the grouped pieces of location information 600b and 610b about the objects around the vehicle by performing clustering based on the pieces of second location information 601b, 602b, 603b, 604b, 605b, 611b, 612b, 613b, 614b, and 615b about one or more objects around the vehicle.

The grouped pieces of location information 600b and 610b about the objects around the vehicle, which are generated as a result of performing clustering, may each represent a probabilistic region in which the corresponding object around the vehicle may be located.

As described above, by fusing and matching the grouped pieces of location information 600b and 610b, which are generated as a result of performing clustering, with the first location information about the mobile device, the influence of noise 601b and 614b in the second location information on the matching result may be reduced. Here, the noise may refer to data having an outlier value that does not belong to any cluster.

Accordingly, the passive entry system providing apparatus may provide more accurate final location information about a mobile device by matching first location information based on grouped pieces of location information, with a minimized influence of noise present in second location information about an object around the vehicle that is recognized by a sensor mounted on the vehicle.

FIG. 6B illustrates the grouped pieces of location information 600b and 610b, which are formed as a result of performing clustering, and the pieces of second location information 601b, 602b, 603b, 604b, 605b, 611b, 612b, 613b, 614b, and 615b belonging to the respective groups. Here, by performing clustering, the passive entry system providing apparatus may prevent the noise 601b and 614b in the pieces of second location information from being matched with the first location information. Accordingly, the passive entry system providing apparatus may provide final location information about the mobile device with improved accuracy.

In some embodiments, the passive entry system providing apparatus may match the first location information by using a cluster centroid or a representative value of the grouped pieces of location information, but the target to be matched with the first location information is not limited to the examples described above.

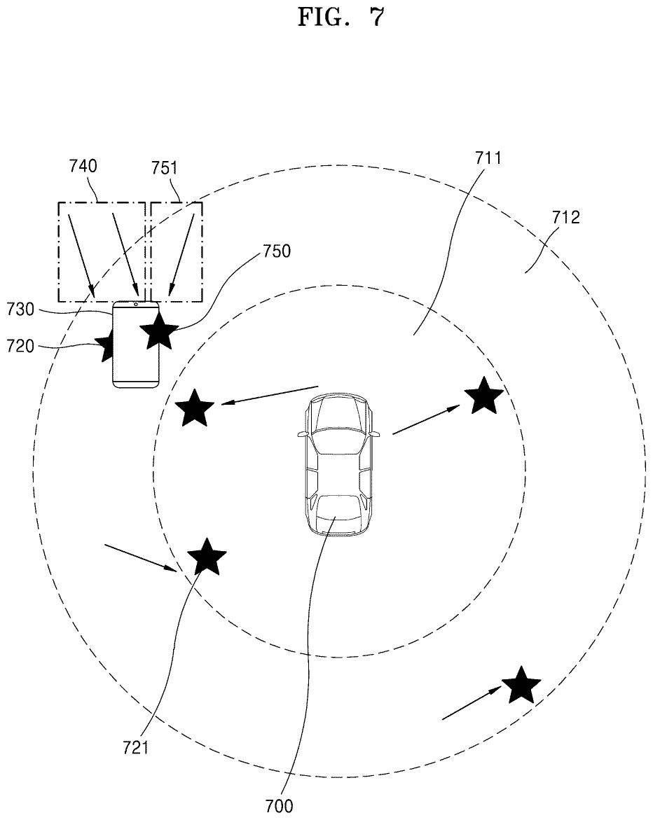

FIG. 7 is a diagram schematically illustrating a mobile device 730, objects 720, 721, and 750 around a vehicle 700, and zones partitioned around the vehicle 700, together with changes in the locations of the mobile device 730, the objects 720, 721, and 750 around the vehicle 700 over time, according to an embodiment.

According to an embodiment, the passive entry system providing apparatus may determine whether first location information and second location information match, based on a change in the first location information over time and a change in the second location information over time.

In some embodiments, the passive entry system providing apparatus may track changes 740 and 751 in location over time for the respective pieces of location information, and when the changes in location over time match (e.g., 740), determine that the second location information about the object 720 around the vehicle matches the first location information about the mobile device 730.

Referring to FIG. 7, when there are a plurality of objects 720 and 750 around the vehicle whose locations overlap with the mobile device 730, the passive entry system providing apparatus may determine that the mobile device 730 matches the object 720 around the vehicle whose changes in location over time (e.g., 740 and 751) match. That is, through the process described above, the passive entry system providing apparatus may correctly determine final location information about the mobile device even when there are a plurality of objects 720 and 750 around the vehicle whose locations overlap with the mobile device 730.

According to another embodiment of the present disclosure, when determining whether the first location information and the second location information match, the passive entry system providing apparatus may vary the criterion for determining a match according to zones 711 and 712 in which the mobile device 730 or the objects 720, 721, and 750 around the vehicle are located.

Here, the zones 711 and 712 may refer to circular areas that are centered on the vehicle 700 and each have a radius corresponding to a distance from the vehicle 700. In some embodiments, each of the zones 711 and 712 is distinguished according to its distance from the vehicle 700 and may have a larger radius as the distance from the vehicle 700 increases.

According to an embodiment, the passive entry system providing apparatus may set two zones 711 and 712 centered on the vehicle 700. Here, the zone 712 having the larger radius may be referred to as a Welcome zone, and the zone 711 having the smaller radius may be referred to as an ‘Unlock zone’. In some embodiments, the operation of the vehicle 700 to be controlled may differ depending on the zone 711 or 712 to which the mobile device 730 belongs. The number and names of the zones 711 and 712 are not limited to those described above.

As described above, when determining whether the first location information and the second location information match, the passive entry system providing apparatus may vary the criterion for determining a match according to the zones 711 and 712. Hereinafter, the criterion for determining a match according to the zones 711 and 712 will be referred to as a zone-specific determination model.

According to an embodiment, to select a zone-specific determination model to be used for determining a match, the passive entry system providing apparatus may determine whether the mobile device 730 is included in each of the zones 711 and 712, by using the first location information about the mobile device 730. In some embodiments, the passive entry system providing apparatus may determine whether one or more objects 720, 721, and 750 around the vehicle 700 are included in each of the zones 711 and 712, based on second location information about at least one object.

As described above, the passive entry system providing apparatus may determine the zone 711 or 712 to which the mobile device 730 and the objects 720, 721, and 750 around the vehicle that match the mobile device 730 belong. According to FIG. 7, the passive entry system providing apparatus may determine that the mobile device 730 and the objects 720 and 750 around the vehicle belong to the zone 712, which has a large radius and is centered on the vehicle 700.

Location information about an object that is far from the vehicle 700 may have a larger variance value than location information about an object that is close to the vehicle 700. Here, the zone-specific determination model may vary the matching criterion by considering the variance value of the location information, which changes according to the distance from the vehicle 700.

In some embodiments, a matching criterion with a large tolerance may be set for the zone 712, which has a larger radius centered on the vehicle 700. On the contrary, a matching criterion with a small tolerance may be set for the zone 711, which has a smaller radius centered on the vehicle 700. In this way, the passive entry system providing apparatus may increase matching accuracy by varying the zone-specific determination model according to the distance from the vehicle 700 to apply different matching criteria.

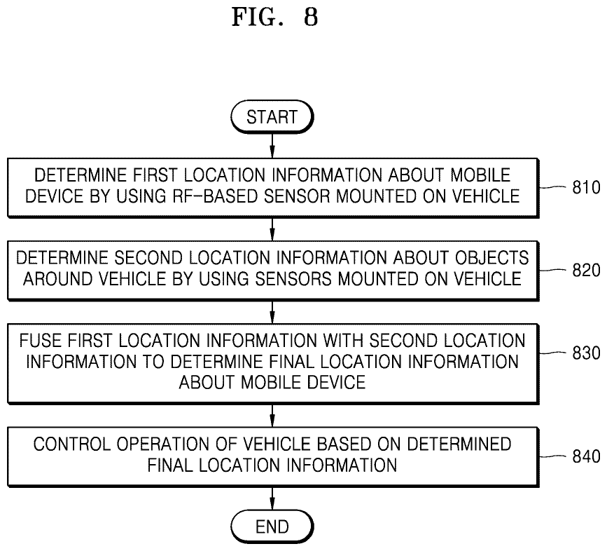

FIG. 8 is a flowchart of a method of performing a passive entry operation by using a vehicle sensor, according to an embodiment.

In some embodiments, in operation 810, the passive entry system providing apparatus may determine first location information about a mobile device by using an RF-based sensor mounted on a vehicle, to perform a passive entry operation using vehicle sensors.

In some embodiments, in operation 820, the passive entry system providing apparatus may determine second location information about at least one object around the vehicle by using sensors mounted on the vehicle.

Here, the number and types of sensors used to determine the second location information about at least one object around the vehicle may vary. In some embodiments, to determine second location information by using information obtained by sensors of multiple types mounted on the vehicle, the passive entry system providing apparatus may perform preprocessing on the information obtained by the sensors of multiple types mounted on the vehicle to convert the information to a common format.

In some embodiments, in operation 830, the passive entry system providing apparatus may fuse the first location information with the second location information to determine final location information about the mobile device. Here, the passive entry system providing apparatus may determine the final location information about the mobile device by determining whether the first location information and the second location information match. In some embodiments, when the first location information and the second location information overlap, the passive entry system providing apparatus may determine the final location information about the mobile device by considering both pieces of location information.

In some embodiments, the passive entry system providing apparatus may determine the final location information about the mobile device by using a location average between the matching first location information and second location information. Here, the obtained location average may be determined as the final location information about the mobile device, but the method of determining the final location information about the mobile device is not limited thereto. In some embodiments, the passive entry system providing apparatus may determine the final location information about the mobile device by using a location average in second location information about a plurality of objects around the vehicle that are determined to match the location of the mobile device. Likewise, the obtained location average may be determined as the final location information about the mobile device, but the present disclosure is not limited thereto.

In some embodiments, the passive entry system providing apparatus may perform clustering on location information, and fuse the grouped pieces of location information about objects around the vehicle with the first location information about the mobile device to determine whether a match occurs. Here, the grouped pieces of location information about the objects around the vehicle, which are generated as a result of performing clustering, may each represent a probabilistic region in which an object around the vehicle may be located.

In some embodiments, in operation 840, the passive entry system providing apparatus may control an operation of the vehicle based on the determined final location information. The determined final location information may refer to location information about the mobile device, and may further refer to location information about a user carrying the mobile device. Here, the operation of the vehicle to be controlled based on the determined final location information may vary. In an embodiment, the passive entry system providing apparatus may determine whether to unlock a door of the vehicle, based on the determined final location information. The operation of the vehicle to be controlled is not limited to that described above.

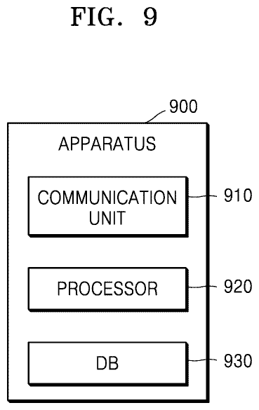

FIG. 9 is a block diagram of a passive entry system providing apparatus according to an embodiment.

Referring to FIG. 9, a passive entry system providing apparatus 900 may include a communication unit 910, a processor 920, and a database (DB) 930.

The communication unit 910 may include one or more components that enable wired/wireless communication with an external server or an external device. For example, the communication unit 910 may include at least one of a short-range communication unit (not shown), a mobile communication unit (not shown), and a broadcast receiver (not shown).

The DB 930 is a hardware component that stores various pieces of data processed by the passive entry system providing apparatus 900, and may store a program for the processor 920 to perform processing and control.

The DB 930 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 920 controls the overall operation of the passive entry system providing apparatus 900. For example, the processor 920 may execute programs stored in the DB 930 to control the overall operation of an input unit (not shown), a display (not shown), the communication unit 910, the DB 930, and the like. The processor 920 may execute programs stored in the DB 930 to control the operation of the passive entry system providing apparatus 900.

The processor 920 may control at least some of the operations of the passive entry system providing apparatus 900 described above with reference to FIGS. 6 to 9.

For example, the processor 920 may determine first location information about a mobile device by using an RF-based sensor mounted on a vehicle, determine second location information about objects around the vehicle by using sensors mounted on the vehicle, determine final location information about the mobile device by fusing the first location information with the second location information, and control an operation of the vehicle based on the final location information about the mobile device.

The processor 920 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

According to the present disclosure, a method of providing a passive entry system by fusing an RF-based sensor with a vehicle sensor may be implemented.

According to the present disclosure, a passive entry system that fuses an RF-based sensor with a vehicle sensor may be implemented, thereby providing a passive entry system with improved accuracy to a user.

The embodiments of the present disclosure described above may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

In addition, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

Particular executions described herein are merely examples and do not limit the scope of the present disclosure in any way. For the sake of brevity, related-art electronics, control systems, software and other functional aspects of the systems may not be described in detail. Furthermore, line connections or connection members between elements depicted in the drawings represent functional connections and/or physical or circuit connections by way of example, and in actual applications, they may be replaced or embodied with various suitable additional functional connections, physical connections, or circuit connections. In addition, no item or component is essential to the practice of the present disclosure unless the item or component is specifically described as being “essential” or “critical”.

The term ‘the’ and other demonstratives similar thereto in the specification of the present disclosure (especially in the following claims) should be understood to include a singular form and plural forms. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of the methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Also, numerous modifications and adaptations will be readily apparent to those skilled in the art without departing from the spirit and scope of the present disclosure.

What is claimed is:

1. A method of performing a passive entry operation by using a vehicle sensor, the method comprising:
determining first location information about a mobile device by using a radio-frequency (RF)-based sensor mounted on a vehicle;
determining second location information about at least one object around the vehicle by using at least one sensor mounted on the vehicle;
determining final location information about the mobile device by fusing the first location information with the second location information; and
controlling an operation of the vehicle based on the final location information about the mobile device.

2. The method of claim 1, wherein the determining of the final location information about the mobile device by fusing the first location information with the second location information comprises determining whether the first location information and the second location information match, by using the first location information about the mobile device and the second location information about the at least one object around the vehicle.

3. The method of claim 2, wherein the determining of whether the first location information and the second location information match comprises determining whether the first location information and the second location information match, based on a change in the first location information over time and a change in the second location information over time.

4. The method of claim 2, wherein the determining of whether the first location information and the second location information match comprises:
distinguishing zones based on a distance from the vehicle; and
varying, according to the zones, a criterion for determining whether the first location information and the second location information match.

5. The method of claim 1, further comprising, in the determining of the final location information about the mobile device by fusing the first location information with the second location information, correcting an error in the first location information based on the second location information.

6. The method of claim 1, wherein in the determining of the second location information about the at least one object around the vehicle by using the at least one sensor mounted on the vehicle, sensors of multiple types mounted on the vehicle are used.

7. The method of claim 6, further comprising converting, to a common format, information obtained through the sensors of the multiple types mounted on the vehicle.

8. A computer-readable recording medium having stored therein a program for executing the method of claim 1.

9. An apparatus comprising:
a memory storing at least one program; and
a processor configured to execute the at least one program to perform an operation,
wherein the processor is further configured to determine first location information about a mobile device by using a radio-frequency (RF)-based sensor mounted on a vehicle, determine second location information about at least one object around the vehicle by using at least one sensor mounted on the vehicle, determine final location information about the mobile device by fusing the first location information with the second location information, and control an operation of the vehicle based on the final location information about the mobile device.
